(19) United States
(12) Patent Application Publication
(10) Pub. No.: US 2009/0249190 A1
(43) Pub. Date: Oct. 1, 2009

(54) METHOD AND APPARATUS FOR PROCESSING STRUCTURED DOCUMENTS

(76) Inventor: Kevin JONES, Harrogate (GB)

Correspondence Address: PEARL COHEN ZEDEK LATZER, LLP, 1500 BROADWAY, 12TH FLOOR, NEW YORK, NY, 10036, US

(21) Appl. No.: 12/058,819

(22) Filed: Mar. 31, 2008

(51) Int. Cl. G06F 17/00

(52) U.S. Cl. 715/234

(57) ABSTRACT

A method of processing documents (e.g., extensible markup language XML documents) includes for example receiving a document, transcoding data of the document from an original character set into a parser character set, parsing the transcoded data, determining a structure profile of the document and applying an expectation model for a next document based on the structure profile of the document to determine the structure profile of the next document. A computer program and apparatus are also disclosed. Other embodiments are described and claimed.

### BACKGROUND OF THE INVENTION

There has been much research in the XML (extensible markup language) and semi-structured data communities on using structural guides to dynamically optimize XML query processing over persistent data and separately, and to a lesser extent, in statically using data schema information to improve parsing of data.

XML processing of transient XML data (short-lived XML data, e.g. used in a messaging application, which may typically consume a significant proportion of all the processing time) can be split into several phases. The exact combination used depends on the application but it may logically start with the transcoding of the data from its original character set into the character set of the parser, which is usually followed by a parsing process and then commonly by some combination of schema validation, XPath processing and application data binding (e.g. the mapping of data into application specific constructs such as objects). The first three parts of this process may be generative in that they create successively higher-level abstractions from the data. The other two stages are filter processes: they may extract interesting parts of the data for secondary processing.

In a classic construction of these processing components in software all stages may be independent so data may be passed between them using standardized interfaces to aid component modularity. There are many ways in which the structure of XML documents can be described. The most commonly used validation model is the World Wide Web Consortium™ (W3C) XML Schema that provides a way for defining the structure, content and semantics of XML documents. Each schema is capable of validating that a document belongs to a certain class of documents. In this sense each schema can also be viewed as defining a “type” for documents, e.g. this document is a ‘purchase order’ type.

### BRIEF DESCRIPTION OF THE DRAWINGS

The subject matter disclosed in this application is particularly pointed out and distinctly claimed in the concluding portion of the specification. Embodiments of the invention, however, both as to organization and method of operation, together with objects, features and advantages thereof, may best be understood by reference to the following detailed description when read with the accompanied drawings in which:

FIG. 1 is a block diagram of an apparatus for XML processing using an expectation model, according to embodiments of the present invention.

FIG. 2 is a flow chart of a process for XML processing using an expectation model, according to embodiments of the present invention.

FIG. 3 illustrates a computing device, according to embodiments of the present invention.

It will be appreciated that for simplicity and clarity of illustration, elements shown in the drawings have not necessarily been drawn accurately or to scale. For example, the dimensions of some of the elements may be exaggerated relative to other elements for clarity or several physical components included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION

In the following detailed description, numerous specific details are set forth in order to provide a thorough understanding of embodiments of the invention. However it will be understood by those of ordinary skill in the art that the embodiments of the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

XML documents are discussed as being used with embodiments of the invention as an example, but processing techniques and devices according to embodiments of the present invention are also applicable to other forms of data processing, where the data may be considered to be for example tree-structured, such as, for example, HTML (hyper text markup language) processing, other forms of semi-structured data and binary message processing. Other types of structured documents may be used.

According to embodiments of the present invention an expectation model or models may be used to improve the efficiency of document processing. An initial expectation model or models may be created from a statically defined starting model or by extracting information from one or more schemas, such as W3C schema documents. The expectation model (or models) may be refined during processing to increase their accuracy and so improve the efficiency of processing. A single expectation model may be used for all documents or (where permitted by the context of use) different sets of documents may have individual expectation models to further aid efficiency.

While it would be possible to base an expectation model around W3C Schema, not all processing scenarios require a schema and the schema “type” model may be both overly complex and lacking in some levels of detail for this purpose. However, to avoid duplicating document models it may be advantageous with respect to embodiments of the present invention to have significant overlap with the model used by W3C Schema.

In a processing model according to one embodiment the standardized interfaces may be extended to include expectation information that may be obtained from an annotated model of the XML document's permissible and likely structure. The expectation information may give probabilities between alternatives. According to embodiments of the present invention this additional information may be employed in each component to optimize the processing stages, for example by biasing instruction selection to process documents using the most likely structure quicker. In some embodiments of the present invention merging of the processing stages may be proposed to further enhance the facility of the expectation data and also reduce processing costs.

A possible model for representing document information is tree regular expressions augmented with counting constructs. This model may possess strong capabilities for representing document structure and also may be decidable for many common algorithms, which is a generally useful property. The model may be further augmented with expectation concerns on critical constructs.

An important construction in a regular expression model is alternation, a choice between possible options, which may be represented as “A|B” for two options A and B. Choices may be simplified between more than two options via grouping to reduce to nested two option cases, e.g. “A|(B|C)”. This may be extended with an expectation by providing a probability that the first option will be matched such as, “A[0.9]|B”, 90% of cases will be ‘A’. As alternations are unordered this form allows for arbitrary placement of expectation information within a regular tree model.

Regular expressions may also support many forms of quantification such as the sign ‘?’ meaning zero or one. For generalized counting however a range quantification of the form “expr(m,n)” may be used, where there are between m and n instances of “expr”, this may also be used to subsume the standard quantifiers if m and n are values between 0 and Infinity and n>=m. To expand this generalized counting quantification to include expectation information it is de-normalized into multiple quantifications joined by alternation. For example, consider “e(3,6)”. This expression may be de-normalized to “e(3,3)[0.5]|(e(3,5)[0.25]|(e3,6))” meaning a count of three will occur 50% of the time while a count of 4 or 5 is only likely in 12.5% of cases (0.5*0.25) which leaves a residual of 37.5% cases likely being of count 6. In this case first-match semantics may be assumed for the expression, this means the overlap in ranges may not be a concern, as only the first acceptable option will be selected.

An expectation model according to embodiments of the present invention may use terminology and representations as discussed above and herein, or other suitable representations and terminology. An expectation model according to some embodiments may also support interleaving operators inherited from XML Schema, for example the “AND” operator, e.g. “A AND B” which may describe containing either or both A and B exactly once but in any order. Again expectations on alternations may be used but by changing the interleaving operator into a concatenation operator, a “,”. For example, one may write “(A,B)[0.9]|(B,A)” implying the combination “A,B” will occur in 90% of cases. For interleaving of many options it may be possible to choose to only expand some combination, e.g. “(A,B,C)[0.1]|(A,C,B)[0.1]|(A & B & C)”, by again exploiting first-match semantics.

By using these extensions with a tree regular expression model of a document, the possible shapes of the documents being processed may be captured, and also the expected shapes. By propagating this model to each processing component the algorithms used can be optimized for processing documents of that shape. The effectiveness of the optimization may be related to the diversity of the document being processed, the less diverse the more effective the optimizations can be. In the extreme, the processing components could be optimized to process documents with no variation at all.

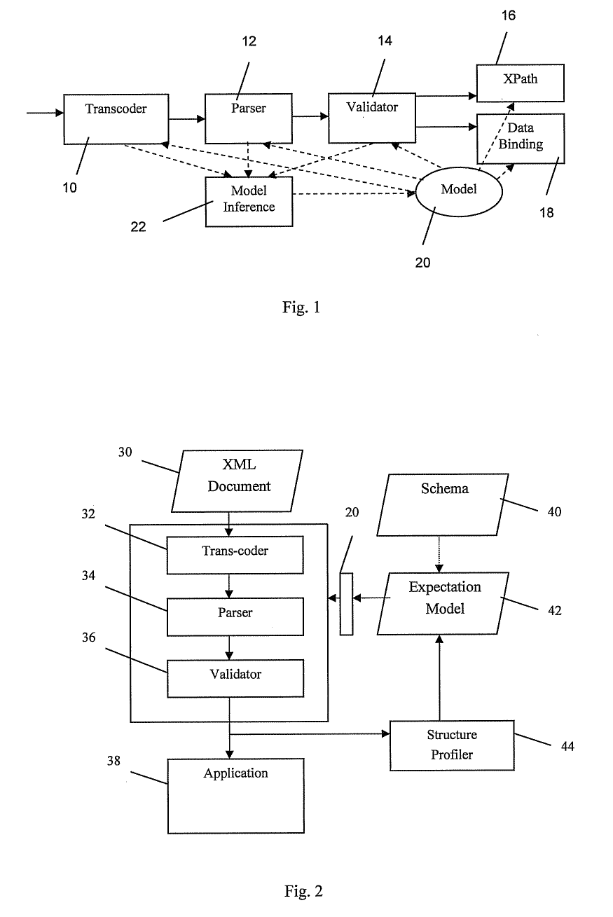

Reference is now made to FIG. 1, which is a block diagram of an apparatus for XML processing using an expectation model, according to embodiments of the present invention. XML processing components may include a transcoder 10, a parser 12, and an optional validator 14, which outputs to XML path language (e.g., Xpath) 16 and data binder 18. An expectation model 20 is provided, which issues an expectation prediction 22 that is applied. The dotted lines indicate the flow of model/expectation information. Notice that this figure presents a feedback model with the initial processing components driving the feedback and all components making use of the feedback output (e.g., the model). An implementation may also gain benefit from merging the processing components although this is not a requirement according to the present invention as long as each can communicate to/from the model processing components.

Expectation model 20 may be constructed in many ways. One embodiment uses a regular tree type inference, which is known, and/or a W3C Schema. In the case of a W3C schema the model produced may be only initial because the regular tree model can express variation at a finer granularity. This property may be useful for expressing expectations. For example, a schema may capture that an “a” element is allowed, but a regular tree model could distinguish between the common representation such as “<a><text></a>” and the shorthand empty form of “<a/>”.

The granularity of the documents model may allow for a classic performance/memory tradeoff. Fine-grained models may create more opportunity for component specialization and thus may use more memory in those specializations. In memory constrained environments it may be appropriate to use varying granularity modeling to allow for optimal balancing of performance within a fixed memory size. Within the context of a model the expectations can be calculated by monitoring the selection of alternatives. As this process may incur with small processing overhead it may be performed in a way similar to profile-guided optimizations, e.g. sampling may be constrained over some set of processing and the outcome of that sampling is then used to perform specialization only once.

According to embodiments of the present invention probabilities may be used on regular trees with counting which may improve the performance of the transient XML processing stages of parsing, validation XPath and data binding.

Although shown the in the context of transient XML processing embodiments of the invention are also applicable to other forms of data processing where the data can be consider to be tree structured in some way, for example HTML processing or binary message processing.

According to embodiments of the present invention a data model annotated with expectations may be used to improve processing stages.

Embodiments of the invention may use an expectation model to extract meaning from data. This may use a similar modeling approach but does not target processing efficiency. Schema specific XML parsing has been employed before but without reference to probability models. Probability models have also been used in database querying but without reference to increasing the processing efficiency of the transient data processing.

Embodiments of the present invention may be used in a variety of applications. Although the present invention is not limited in this respect, the components and techniques disclosed herein may be used in many apparatuses such as personal computers (PCs), wireless devices or stations, video or digital game devices or systems, image collection systems, processing systems, visualizing or display systems, digital display systems, communication systems, and the like.

FIG. 2 is a flow chart of a process for XML processing using expectation model, according to embodiments of the present invention. An XML document 30 may be received. XML document 30 may be transcoded by a transcoder 32 from its original character set to for example a parser character set. The transcoded data may be parsed by parser 34 and the parsed data may be validated by validator 36 for schema validation. The processed data may undergo further processing, such as, for example, XPath processing and application data binding (e.g. the mapping of data into application specific constructs such as objects). The structure profiler 44 may extract the profile of the processed XML document and the profile may be fed into the expectation model 20. Based on a predetermined schema 40 the expectation model 20 may be able to issue an expectation prediction 22, which may be used when the next XML document is processed, thus rendering the continuous processing of XML documents more efficient. The more the processed XML documents are related the more efficient the adaptive processing according to embodiments of the present invention is. An application 38 may then use the processed data.

The expectation model 20 may be, for example, stored in a memory for later use. For example, the expectation prediction may be applied to a future XML document rendering processing of a future document more efficient.

Other operations or series of operations may be used.

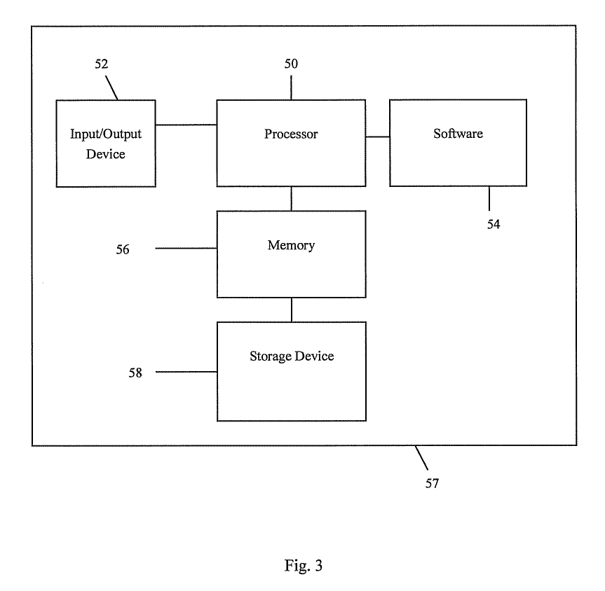

FIG. 3 illustrates a computing device, according to embodiments of the present invention. Computing device 57 may be for example a personal computer, workstation, wireless device or station, cellular telephone, personal digital assistant, or other suitable computing device. Computing device 57 may include a processor 50, input/output device 52, software 54, memory 56 and storage device 58. Processor 50 may include one or more processors or controllers, such as one or more microprocessors. Software 54 may be stored in for example memory 56 and/or storage device 58, and executed by processor 50. Memory 56 may be or include, for example, any type of memory or memory device, such as static or dynamic random access memory or magnetic or optical disk memory, or other volatile or non-volatile memory devices suitable for server or general applications. One or more memories or types of memories may be included. Memory 56 may be used to store instructions to be executed by and data to be operated on by processor 50, or for example operating system software, application software, or user data. Storage device 58 may include one or more long-term storage devices, such as disk drives, flash memories, or other devices.

Some embodiments of the invention may include a system, such as that shown in FIG. 3, which executes instructions or otherwise processes data to carry out methods as discussed herein.

Data structures such as XML document 30, expectation model 20 and predetermined schema 40 may be stored in memory 56. Modules such as transcoder 32, parser 34, validator 36, structure profiler 44 may be for example stored as software 54 and may be executed by processor 50, but other forms for such modules and other ways of executing such functionality may be used.

Embodiments of the invention may include an article such as a computer or processor readable medium, or a computer or processor storage medium, such as for example a memory, a disk drive, or a USB flash memory, encoding, including or storing instructions which when executed by a processor or controller, carry out methods disclosed herein. For example, all or a portion of software 54 may be stored on a flash memory, and all or part of memory 56 or storage device 58 may include a flash memory.

While the invention has been described with respect to a limited number of embodiments, it will be appreciated that many variations, modifications and other applications of the invention may be made. Embodiments of the present invention may include other apparatuses for performing the operations herein. Such apparatuses may integrate the elements discussed, or may comprise alternative components to carry out the same purpose. It will be appreciated by persons skilled in the art that the appended claims are intended to cover all such modifications and changes as fall within the true spirit of the invention.

1. A method comprising:
receiving a first document;
transcoding data of the first document from an original character set into a parser character set;
parsing the transcoded data;
determining a structure profile of the first document; and
applying an expectation model on a next document based on the structure profile of the document to determine the structure profile of the next document.

2. The method as claimed in claim 1, comprising validating the parsed data according to a predetermined schema.

3. The method as claimed in claim 1, comprising processing the profile of the document using Xpath processing.

4. The method as claimed in claim 1, comprising data binding of the profile of the document.

5. The method as claimed in claim 1, wherein the first document and the next document each comprises an extensible markup language (XML) document.

6. The method as claimed in claim 1, comprising saving the expectation model in memory.

7. A processor-readable storage medium having stored thereon instructions that, if executed by a processor, cause the processor to perform a method comprising:
receiving a first document;
transcoding data of the first document from an original character set into a parser character set;
parsing the transcoded data;
determining a structure profile of the first document; and
applying an expectation model on a next document based on the structure profile of the document to determine the structure profile of the next document.

8. The processor-readable storage medium of claim 7, having stored thereon instructions that, if executed by a processor, cause the processor to perform a method comprising validating the parsed data according to a predetermined schema.

9. The processor-readable storage medium of claim 7, having stored thereon instructions that, if executed by a processor, cause the processor to perform a method comprising processing the profile of the document using Xpath processing.

10. The processor-readable storage medium of claim 7, having stored thereon instructions that, if executed by a processor, cause the processor to perform a method comprising data binding of the profile of the document.

11. The processor-readable storage medium of claim 7, having stored thereon instructions that, if executed by a processor, cause the processor to perform a method wherein the first document and the next document each comprises an extensible markup language (XML) document.

12. The processor-readable storage medium of claim 7, having stored thereon instructions that, if executed by a processor, cause the processor to perform a method comprising saving the expectation model in memory.

13. An apparatus comprising:
a transcoder to transcode data of a first document from an original character set into a parser character set;
a parser to parse the transcoded data;
a structure profiler determining a structure profile of the first document; and
an expectation model to be applied to a next document based on the structure profile of the document to determine the structure profile of the next document.

14. The apparatus as claimed in claim 10, further comprising a validator to validate the parsed data according to a predetermined schema.

15. The apparatus as claimed in claim 10, further comprising Xpath processor to process the profile of the document.
